(19) United States
(12) Patent Application Publication
(10) Pub. No.: US 2008/0305227 A1
(43) Pub. Date: Dec. 11, 2008

(54) French Fry Chipboard Container Cover

(76) Inventor: Terry Gebhardt, Kilgore, TX (US)

Correspondence Address: Welsh & Katz, Ltd., 22nd Floor, 120 South Riverside Plaza, Chicago, IL, 60606-3912, US

(21) Appl. No.: 11/761,262

(22) Filed: Jun. 11, 2007

(51) Int. Cl. A47J 41/00; A23L 1/48; A47J 43/00

(52) U.S. Cl. 426/418; 99/646 C

(57) ABSTRACT

The present invention includes a device and a method of creating and using the device for maintaining the resonant temperature of a fried food product. The present invention is directed to a container cover comprised of two flat material pieces attached to one another to form an envelope-like structure with two or more sealed edges, an open end and a space between the material pieces and the creation of such a container. Additionally, the present invention is directed to a method of extending the duration of the resonant temperature of a fried food product by inserting a container of fried food products into the container cover of the present invention and attaching the container cover to the food container.

### FIELD OF THE INVENTION

The present invention is directed to an apparatus and method for use of the apparatus for maintaining the temperature of fried foods after cooking. In particular the device comprises a container for cooked French fries and the method of storing, making available, filling and using the container by food producers namely restaurants.

### BACKGROUND OF THE INVENTION

Fried food production is an international multi-billion dollar per year industry. Of the myriad of products available in this business category, none is more popular than the French fry. People all around the world regularly enjoy munching on these little fried potato sticks because when fresh they are warm and crispy with a smooth flavor. However, if a consumer is unable to eat his fries almost immediately, he may be subjected to a most unpleasant culinary experience—soggy French fries.

Once French fries are removed from the oil they are fried in, they begin to rapidly degrade. A typical deep fryer used to make fries has an oil temperature upwards of 340 degrees Fahrenheit. That means that while cooking, a fry has a temperature of about 340 degrees at its surface and about 212 degrees at its core. During the cooking process, water inside the potato is converted to steam which escapes from the fry. This leaves room for some of the oil to then seep into the fry and form the familiar crispy crust on the outside of the fry. However, since the core only gets to around 212 degrees, some water and steam remains trapped inside the potato core. Once removed from the cooking oil, the fry is exposed to significantly cooler ambient temperatures. This temperature change causes the moisture still trapped inside the fry to condense thus over time turning the fry into a soft soggy mess. When in a restaurant cooked fries are typically kept beneath warming lights that prevent the rapid cool down, and subsequent soggy fries situation, until they can be delivered and consumed.

Many French fry consumers such as drive-thru and carry-out patrons are unable to eat their French fries immediately after purchase. By the time they get to them, their fries are limp and soggy because the fries are exposed to a relatively low temperature for an extended time before consumption. However, if the temperature of the fries could be kept higher, more time could elapse before the fries become soggy. Therefore, it would be helpful and beneficial to have a way to mitigate the temperature difference that fries are exposed to during transport or some other delay between cooking and consumption thus allowing all consumers to enjoy the warm crispy snack they were craving.

### SUMMARY OF THE INVENTION

The present invention is directed to a device and method of using the device to help maintain the resonant temperature of a fried food product. The resonant temperature of a product is that temperature that occurs at the moment that the product achieves its desired flavor and texture. In particular the present invention is directed to a container cover comprised of two flat material pieces attached to one another to form an envelope-like structure with two or more sealed edges, an open end and a space between the material pieces. The material used to create the container cover must provide the proper moisture vapor transfer rate depending on the particular application. Further, the container cover is die cut to a shape to aid in loading containers of food product and storage.

Additionally, the present invention is directed to a method of maintaining the resonant temperature of a fried food product. This method includes filling a chipboard container with a fried food product, placing the chipboard container into the open end of a container cover and closing the open end. Furthermore, the method includes attaching the closed end of the container cover to the chipboard container. Various methods of attachment are available including a slit in the chipboard container, adhesive on the chipboard container or die cutting triangular slits in a circular pattern on the chipboard container.

Further objects, features and advantages of the present invention will be apparent from the following description and the appended claims when taken in conjunction with the accompanying drawings.

### BRIEF DESCRIPTION OF THE DRAWINGS

FIG. 1 is an elevational view of the container cover of the present invention.

FIG. 2 is a perspective view of the container cover in use in conjunction with a food container.

FIG. 3 is perspective view of the container cover illustrating its attachment to a modified chipboard container using the method of the present invention.

FIG. 4 is an elevational view of a chipboard container used in association with the device of the present invention.

FIG. 5 is a schematic representation of a process of manufacturing container covers of the present invention.

### DETAILED DESCRIPTION OF THE ILLUSTRATIVE EMBODIMENT

While the present invention is susceptible of embodiment in various forms, there is shown in the drawings a presently preferred embodiment that is discussed in greater detail hereafter. It should be understood that the present disclosure is to be considered as an exemplification of the present invention, and is not intended to limit the invention to the specific embodiment illustrated. It should be further understood that the title of this section of this application (“Detailed Description of the Illustrative Embodiment”) relates to a requirement of the United States Patent Office, and should not be found to limit the subject matter disclosed herein.

In this disclosure, the use of the disjunctive is intended to include the conjunctive. The use of the definite article or indefinite article is not intended to indicate cardinality. In particular, a reference to “the” object or “a” object is intended to denote also one of a possible plurality of such objects.

The present invention is directed to a container cover and a method of using the container cover to maintain the resonant temperature of a fried food product thus preventing it from becoming soggy as quickly as it otherwise would. The food product used could be any of a wide range of fried foods, including but not limited to French fries, onion rings, chicken tenders or chicken wings. However, as detailed below, the fried food product used by way of example for the illustrative embodiment is French fries. Persons having ordinary skill in the art will understand that any one of the above mentioned food products as well as other fried, sauteed, baked, deep fried or other prepared foods, wherein a specific texture exists that can be damaged by ambient conditions, can be substituted therefore without departing from the novel scope of the present invention.

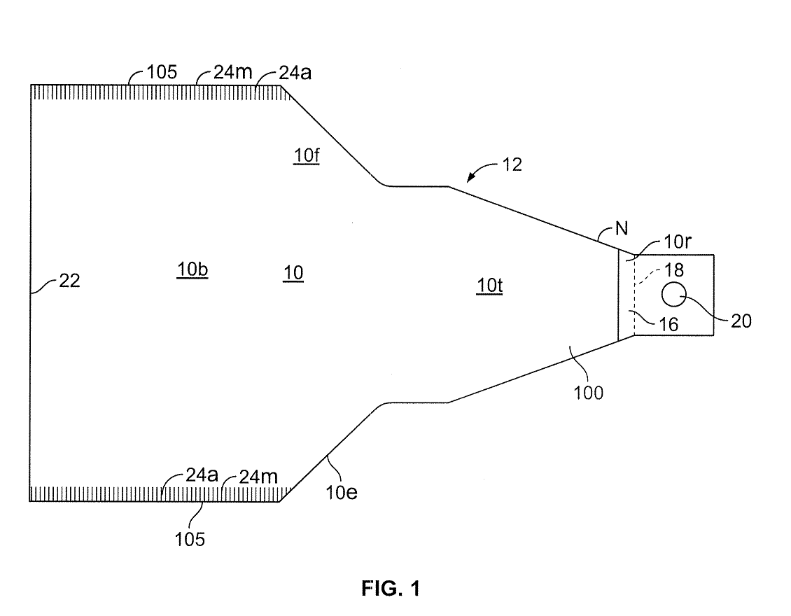

Referring now to FIG. 1, an elevational view of a flat container cover 10 is shown. Here, the container cover 10 is made of uncoated cellophane but in other embodiments any suitable material that provides a proper moisture vapor transfer rate and is suitable for food protection and use, as will be know by persons having ordinary skill in the art, can be used. The shape and size of the container cover 10 facilitate easy loading of a container 30 holding fries 28 and securing the container cover 10 to the fry container 30. The container cover 10 has a header portion 12 for ease of loading and dispensing by providing a holding place when lifting the covers and/or a means of attachment of the covers to a rack for ease of dispersion, but could be produced in a loose format or other formats in other embodiments. Furthermore, a header portion 12, in one embodiment, could be used by a restaurant to indicate source by including a trademark or other source indicator thereon, by printing on the header portion 12 or using some other method to affix the source indicator. The open end 14 of the container cover 10 has both a lip 16 and a perforation 18 where the open end 14 meets the header portion 12 to aid in opening and separation from the header portion 12. It will be understood, by persons having ordinary skill in the art that the lip 16 is the area between the bag opening and the perforation. The area above the lip is referred to as the header 12; the lip 16 stays with the bag 10 whereas the header 12 is what the bag separated from when removed.

In the illustrative embodiment, the header portion 12 has a dispenser hole or slot 20 used for securing container covers 10 to a dispensing platform. Due to the method of manufacture as detailed below where one piece of material is folded over upon itself, the container cover 10 has a fold line 22 running parallel to the perforation 18 and two sealed edges 24 running perpendicular to the perforation 18. It will be understood that fold-line 22 can be made in a manner, such as creasing, to increase the ability to fold, or can merely be an imaginary line at the point in the item where folding is desirable, without departing from the novel scope of the present invention. The sealed edges 24 are created by means of an adhesive of a given width, in a preferred embodiment about 0.1875 inches. In other embodiments, a heat seal or other means for forming sealed edges may be used in place of the adhesive without departing from the novel scope of the present invention. The open end 14 of the container cover 10 is die cut, using methods known to those skilled in the art, to form a container cover having funnel shape 26 so as to aid in loading a filled food container 28 therein. This shape incorporates various angle cuts and radii that extend from the open end 14 through the perforation 18 and exit out each sealed edge 24 of the container cover 10.

In one embodiment of the cover bag 10, of the present invention, shown in FIG. 1, the cover bag 10 has an overall length of approximately 10.75 inches, including a header 12. Header 12, as will be known to persons having ordinary skill in the art, permits bag 12 to be placed on a bag rack for easy access during use. Header 12, in the illustrative embodiment, includes a perforation 18 between header 12 and cover bag 10, permitting the easy tear off of the cover bag 10 from a rack during use. An opening 20 is formed in header 12, in a manner well known in the art, to facilitate hanging cover bag(s) 10 to a rack (not shown).

As will be seen in FIG. 1, cover bag 10, prior to assembly, comprises a single elongated strip of material having a width at its widest point, of approximately 7 inches and also comprises, at either end a narrowed neck portion tapering from approximately 6.5 inches to about 1.25 inches at its narrowest portion N. It will be understood by persons having ordinary skill in the art that the shape of a cover bag blank of the present invention can be precut and rolled or cut prior to final assembly depending on the manner in which the bag will be assembled and the equipment for cutting, rolling and assembly available, all without departing from the novel scope of the present invention.

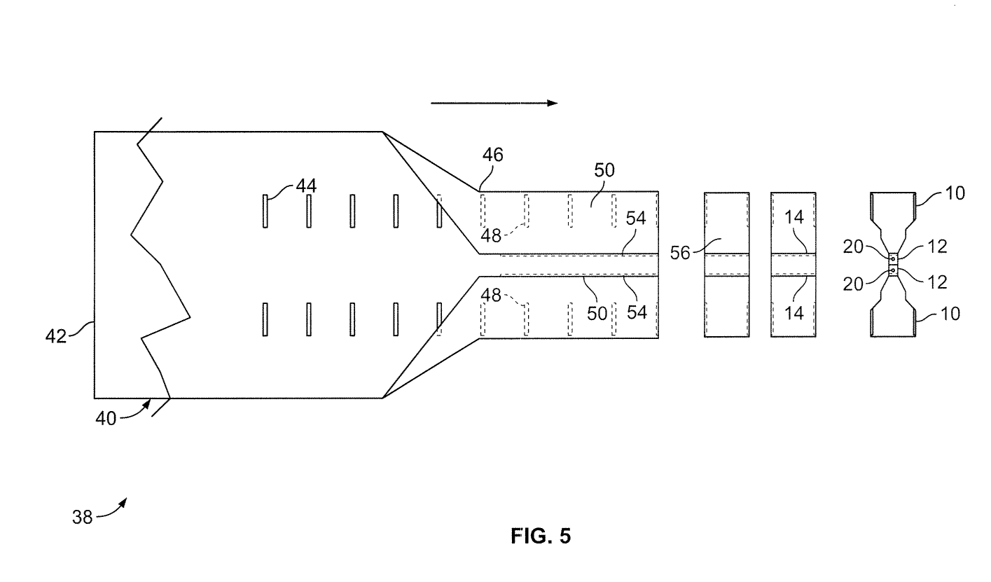

At its widest portion, the bag blank (shown as item 56 in FIG. 5) includes a margin 24 m of about 0.25 inches on each side 24 that, in creation of the bag 10, will be provided with adhesive 24a or other attachment or fastening means, for assembly as cover bag 10 sides 10s. In the assembly of a preferred embodiment, adhesive is places within margins 24 m, the cover bag 10 is folded over at the center, or fold edge 22, and the margins 24 m are adhered together forming an envelope shaped cover bag 10e.

As seen in FIG. 1, envelope shaped cover bag 10e includes a body portion 10b, flap portions 10f and tuck ends 10t (as will be described in greater detail below). In a preferred embodiment, the body portion of the bag is approximately 6.5 inches wide and 3.9 inches long; flap portion 10f is approximately 6.5 inches wide where it is adjacent to body portion 10b and tapers, at an about 44 degree angle to approximately 3.375 inch width where it is adjacent to tuck ends 10t. Tuck ends 10t taper, at an about 20 degree angle, to about 1.25 inches in width at their point of joining, at perforation 18, with header 12.

In the preferred embodiment, cover bag 10 when created has an obverse side 10o and a reverse side 10r; header 12 being attached on one side I Or only. It will be understood that perforation 18 therefore, is only found on the one side 10r having header 12. To aid in opening cover bag 10, tuck portion 10t of obverse side 10o of cover bag 10 can be made slightly shorter. In the preferred embodiment, tuck portion 10t of obverse side 10o is approximately 0.25 inches shorter than its counterpart, lip 16, on tuck portion 10t of reverse side 10r.

It will be understood by persons having ordinary skill in the art that what is illustrated and described is a preferred embodiment of the cover of the present invention and that variations on sizes, angles and other dimensions are possible without affecting the novel scope of the present invention. Further, the dimensions shown have been created for a standard size package of French fries used by a large well known restaurant chain in the United States and that different sized packages of product to be protected will require covers of different sizes and dimensions, but which will generally have similar characteristics to those shown and described herein

The method of manufacture of the container cover 10, of one embodiment of the present invention, includes the steps of unrolling a length of material 40 from a roll of uncoated cellophane film 42 having a width approximately twice the width of the container that will eventually be formed therewith. As noted above, different materials can be used to produce the cover of the present invention, without departing from the novel scope of the invention. The film 40 is unwound from the roll 42 and held such that an adhesive 44 can be applied onto the film. It will be understood by persons having ordinary skill in the art that while an adhesive is used in the present embodiment, various methods of securing parts of the container together, such as welding (including ultrasonic and heart welding as well as spot welding), adhesive tapes and other means and devices can be utilized in the creation of the container cover 10. The film is then folded upon itself 46 leaving a single-layer edge of 1.75″ or more, in a preferred embodiment, either by V-folding or center-folding to form one or two container cover lanes 48 respectively. At this point, the lanes 48 are long continuous tubes of cellophane 40. After the lanes 48 are formed, the film 40 runs through a set of pressure rollers or over an “S wrap” known to those skilled in the art which activates the adhesive changing the lanes from a continuous tube of cellophane to a series of conjoined pockets 50. Then a perforation 52 is made at the open end of each lane 54 which defines a header portion 12. From there the pockets 50 are cut apart with a hot knife or other means along the adhesive to form individual square container covers 56. The covers are then stacked, collated and die cut on the open end 14 to form a particular shape as necessitated by the particular application involved. Finally, the header portion 12 is die cut to add a dispensing hole or slot 20. In a preferred embodiment, opening 20 is cut with a steel rule die on an offline or inline punch press, either in singular form, but most often in a collated form of predetermined number of bags.

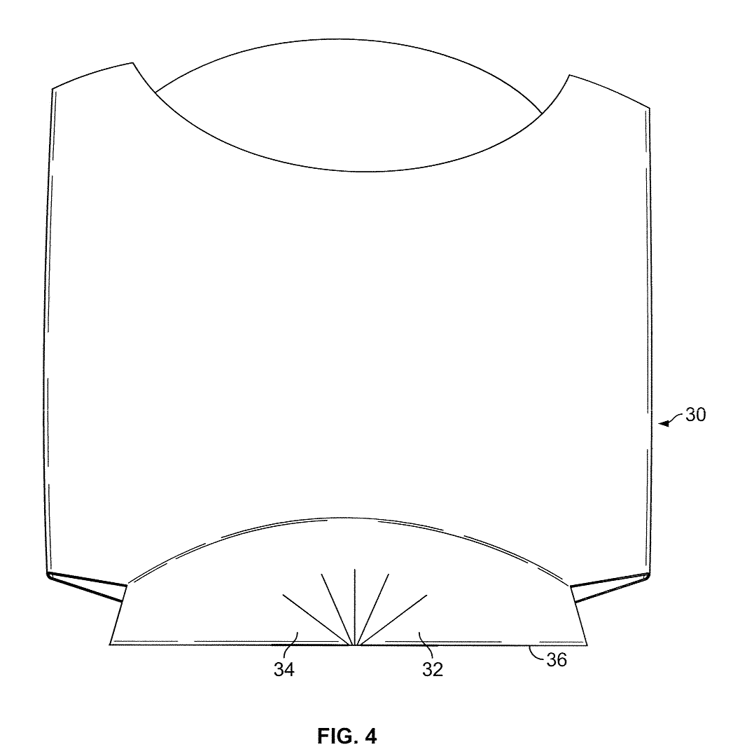

Before the container cover 10 can be used to maintain fry temperature, the typical fry chipboard container 30 must be modified to accept the open end 14 of the container cover 10. It will be understood that chip board containers manufactured to join with a cover product of the present invention can be manufactured ready to mate with the product, without departing from the novel scope of the present invention. This modification, as shown in FIG. 4, is a die cut triangular cut 32 in a circular pattern 34 centered along the bottom edge 36 of the fry container 30. The diameter of the die cut circle is from 1″ to 1.25″ and it has 12 or more triangular cuts within the circle. The triangular cuts point towards the center of the circle with the circumference used as a hinge point. Other modifications for securing the container cover 10 such as a cutting a slit or applying adhesive may be used in other embodiments. It will also be understood that while the present invention has been directed to its use with so called chip-board containers, other types of containers, including paper, plastic and others as well as combination packaging, can be used with the cover of the present invention with departing from the novel scope thereof.

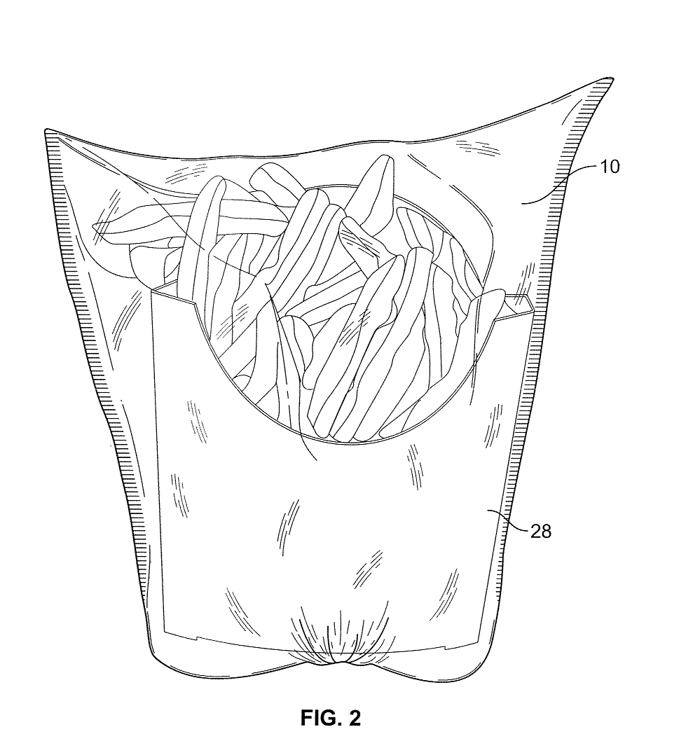

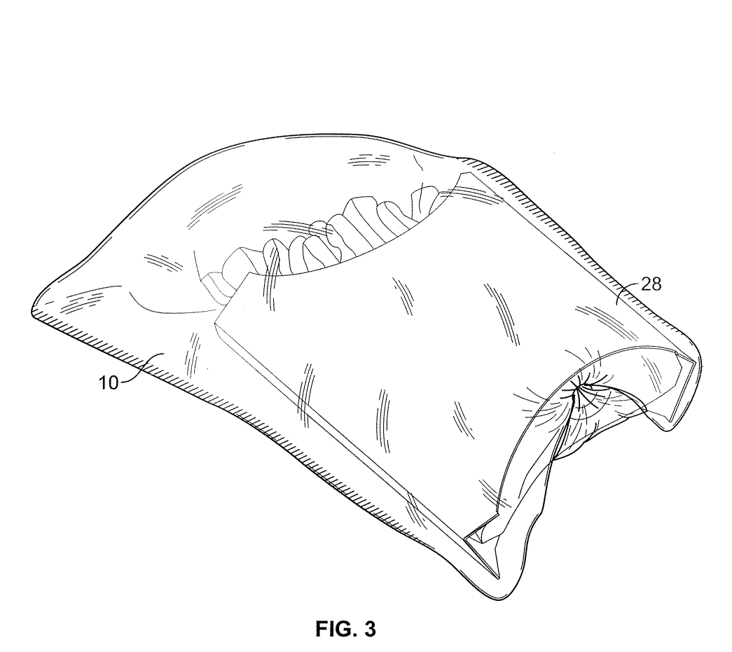

As shown in FIGS. 2 and 3, to maintain approximately the resonant temperature of French fries, the French fries are loaded into a fry container 30 and the filled fry container 28 is inserted into the open end 14 of the container cover 10. Once the filled fry container 28 is inside the container cover 10, the open end 14 is pushed up through the die cut area 34. The action of the triangular cuts creates a drag and catches the ends of the bag 14 to secure them to the full fry container 28. Therefore, heat escaping from the fries is reflected back by the container cover 10 thus maintaining a higher temperature inside the container cover 10 than the ambient temperature and allowing the fries to stay warm and crispy longer.

In a further embodiment, it will be seen that once the food has reached its location for consumption, the consumer can remove container cover 10 to find restaurant fresh product. Typically, such products are oily in nature, and these oils have been known to escape from the paper or chip-board packaging. The consumer, may, upon removal of the container cover 10 from the chipboard container, place the bottom of the chipboard container within the envelope of the container cover 10 and thereby create an effective barrier to prevent oil stains from the foods within the chipboard container.

The specific embodiments of the present invention have been described for the purpose of illustrating the manner in which the invention is made or used. It should be understood that the implementation of other variations and modifications of the invention and its various aspects will be apparent to one skilled in the art, and that the invention is not limited by the specific embodiments described. Therefore, it is contemplated to cover the present invention any and all modifications, variations, or equivalents that fall within the true spirit and scope of the basic underlying principles disclosed and claimed herein.

What is claimed is:

1. A container cover for maintaining temperatures in cooked products, comprising:
an envelope shaped container having an open end dimensioned to slide over and contain the opening of a food package;
the envelope formed from a single sheet of planar material folded over and sealed along its edges;
the envelope further comprising elongated tuck portions for insertion into the food package to maintain the cover and food container in attached relationship

2. The container cover of claim 1 where the sealed edges are created by applying adhesive to the material along the edges and pressing them together.

3. The container cover of claim 1 where the sealed edges are created by folding the edges together and heat sealing the edges.

4. The container cover of claim 1 where the material is comprised of a resin mix that provides a sufficient moisture vapor transfer rate.

5. The container cover of claim 4 where the material is uncoated cellophane.

6. The container cover of claim 1 where the open end and sealed edges are die cut such that the container cover is shaped like the cross-section of a funnel.

7. A method of maintaining approximately the resonant temperature of fried food product comprising:
providing a container cover having an open end dimensioned to slide over and contain the opening of a food package and further comprising elongated tuck portions for insertion into the food package to maintain the cover and food container in attached relationship;
filling a food container with a food product at its resonant temperature;
inserting the food product container into the open end of the container cover;
closing the open end of the container cover about the food product container; and
attaching the elongated tuck portions of the container cover to the food product container.

8. The method of claim 7 further comprising the step of first preparing the food product container for attachment of the container cover.

9. The method of claim 8 wherein preparing the food container includes creating an opening in the food product container for insertion of the elongated tuck portions of the container cover into the opening

10. The method of claim 8 wherein preparing the food container includes die-cutting 12 or more triangular shaped cuts in a circular pattern centered along the bottom edge of the food container such that the elongated tuck portions of the container cover can be inserted and held therein.

11. The method of claim 8 wherein preparing the food container includes cutting a slit in the chipboard container.

12. The method of claim 8 wherein preparing the food container includes applying adhesive to the chipboard container.

13. The method of claim 7 wherein the container cover comprises two funnel shaped planer pieces of uncoated cellophane attached to one another such that three sealed edges and one open end are formed and a space is defined between the cellophane pieces.

14. The method of claim 7 where the food product is French fries.

15. The method of claim 8 where the food container is made of chipboard.

16. A method of using a container cover including the steps of:
providing a container cover having an open end dimensioned to slide over and contain the opening of a food package and further comprising elongated tuck portions for insertion into the food package to maintain the cover and food container in attached relationship;
delivering a food package having a closed bottom and open top with the container cover covering the open top; and
removing the food package from the open top of the container cover and fitting the closed bottom of the container cover within the container cover.
